(19) United States
(12) Patent Application Publication
(10) Pub. No.: US 2003/0115139 A1
(43) Pub. Date: Jun. 19, 2003

(54) Electronic entity records system

(75) Inventors: Monte V. Hurley, Goodyear, AZ (US); Dennis K. Snelling, Phoenix, AZ (US); Evangeline Moreno, Phoenix, AZ (US); Joanne K. Sasser, Phoenix, AZ (US); Tamara L. Gahring, Glendale, AZ (US)

Correspondence Address: Rod S. Berman, Esq., JEFFER, MANGELS, BUTLER & MARMARO LLP, Tenth Floor, 2121 Avenue of the Stars, Los Angeles, CA, 90067, US

(73) Assignee: U-HAUL INTERNATIONAL, INC.

(21) Appl. No.: 10/027,733

(22) Filed: Dec. 19, 2001

(51) Int. Cl. G06F 17/60

(52) U.S. Cl. 705/40

(57) ABSTRACT

An entity records system for tracking information pertaining to a plurality of entities is disclosed. The entity records system preferably includes an entity identification capture to record identification information for each entity, a revenue capture to record revenue information for the entity, a delinquency data capture to record account delinquency information for each entity and a negative payment history capture to track the negative payment history for each entity. The entity records system is preferably available over a network having at least one computer-server in communication with the users.

### FIELD OF THE INVENTION

The present invention relates generally to an electronic entity records system, and more particularly, to a records system that tracks contact information as well as financial, legal, and administrative transactions for a business having numerous centers or dealers.

### BACKGROUND OF THE INVENTION

The equipment rental business, particularly rental of moving equipment, is a pervasive business that is most successful when a rental location exists in each neighborhood. When a customer needs to rent moving equipment, the customer will seek a local business that will provide a truck, dolly, trailer or other such equipment. To provide a convenient rental location for prospective customers, it is in the interest of a central business concern to have dealerships and centers in every neighborhood. For a successful large national company, the number of dealers and centers affiliated with the central business concern could exceed tens of thousands of locations. To maintain management control over these locations, a central business concern will need an entity records system to track contact information, as well as financial, legal and administrative information for each location or entity.

The entities affiliated with the central business concern generally earn a commission based on the gross revenues generated by the rental of equipment or sale of support rental items. To provide an accurate accounting of the commission earned by each entity, there is a need for a system that tracks the commission rate earned by each entity, the gross revenues for each accounting period, and the commission earned for each accounting period. Furthermore, it will be necessary to track any payments made by the central business concern to each entity as commission.

When the central business concern evaluates its business relationship with a particular entity, it will be helpful to know whether the entity has been delinquent in transacting with the central business concern and whether the entity has had an extensive negative payment history. In this regard, it is desirable to provide an entity records system that tracks the number of delinquent transactions for which each entity is responsible, a description of the delinquency and the date on which the delinquency was incurred. Furthermore, it is desirable to track each entity's negative payment history by reporting any returned checks or missing payments for which the entity is responsible.

Accordingly, there is a need for an entity records system that tracks detailed information pertaining to each entity within a central business concern, especially for tracking financial, legal, administrative and contact information.

### SUMMARY OF THE PREFERRED EMBODIMENTS

An electronic entity records system is disclosed for tracking information pertaining to dealers and centers affiliated with a central business concern. The information is stored in the system and is retrievable by a user preferably through the use of graphical interfaces of a browser-based system. In a preferred embodiment, the records system provides contact information, as well as financial, legal and administrative information for the various centers and dealers.

In a preferred embodiment of the invention, the entity records system includes a general information feature that provides contact information such as the name, location, telephone number and hours of operation for each entity. Each entity is preferably identified by an entity number, entity type and entity class.

In addition to providing basic contact information, the system preferably provides a revenue tracking feature that displays the commission and gross revenues earned by each entity. For historical purposes, the system preferably stores commission and gross revenues information for a specified period of time prior to the current date. If a commission check has been paid to the entity, the system preferably provides the check number, date and amount of the payment.

In a preferred embodiment of the invention, the entity records system includes a delinquency tracking feature that reports any delinquent transaction performed by the entity. The delinquency tracking feature preferably displays the number of delinquent transactions for which each entity is responsible. If the central business concern overrides a delinquency, the delinquency tracking feature displays an adjusted delinquency count. A delinquency detail section is provided to specify the date and reason for the delinquency. If an override has been granted, the delinquency detail section also identifies the adjustment and displays an explanation for the adjustment.

The electronic entity records system preferably includes a negative payment history feature that identifies any bank returned checks, company returned checks, and missing checks or bank deposits. If an entity is required to make payments by certified funds, the system will identify the date that the requirement was imposed and the reason for the imposition of the requirement.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:

FIG. 1 depicts a preferred embodiment of the general information feature of the present invention;

FIG. 2 depicts a preferred embodiment of the revenue tracking feature of the present invention;

FIG. 3 depicts a preferred embodiment of the delinquency tracking feature of the present invention;

FIG. 4 depicts a preferred embodiment of the negative payment history feature of the present invention;

FIG. 5 depicts a preferred embodiment of the business codes feature of the present invention;

FIG. 6 depicts a preferred embodiment of the mailing information feature of the present invention;

FIG. 7 depicts a preferred embodiment of the owner identification feature of the present invention;

FIG. 8 depicts a preferred embodiment of the special instructions display of the present invention;

FIG. 9 depicts a preferred embodiment of the contract information feature of the present invention;

FIG. 10 depicts a preferred embodiment of the month to date adjustment report of the present invention;

FIG. 11 depicts a preferred embodiment of the year to date adjustment report of the present invention;

FIG. 12 depicts a preferred embodiment of the pre-formed queries of the present invention;

FIG. 13 depicts a preferred embodiment of the current dealer delinquencies query of the present invention; and

FIG. 14 depicts a preferred embodiment of the response to the current dealer delinquencies query of the present invention.

Like numerals refer to like parts throughout the several views of the drawings.

### DETAILED DESCRIPTION OF THE PREFERRED EMBODIMENTS

The electronic entity records system 10 of the present invention enables a central business concern having multiple centers or dealers to store and retrieve contact information, as well as financial, legal, and administrative information for its various centers or dealers. A “center” as used herein is defined as an entity owned by the central business concern. A “dealer” as used herein is defined as an entity affiliated with the central business concern but owned by an independent contractor. It is envisioned that the electronic entity records system 10 of the present invention can be used in connection with any type of business affiliate, including but not limited to vendors, suppliers, and manufacturers, and is not intended to be limited to any business affiliation specifically described herein. The centers, dealers, vendors, suppliers, manufacturers and other business affiliates are collectively referred to herein as “entities.”

In a preferred embodiment of this invention, the system is used to track information pertaining to centers and dealers. Each center or dealer is part of a route. A route is preferably selected to group dealers or centers that are in the same general geographical area. The central business concern preferably includes a plurality of marketing companies, each marketing company supervising a plurality of routes. More preferably, the central business concern includes a plurality of districts, each district including numerous marketing companies.

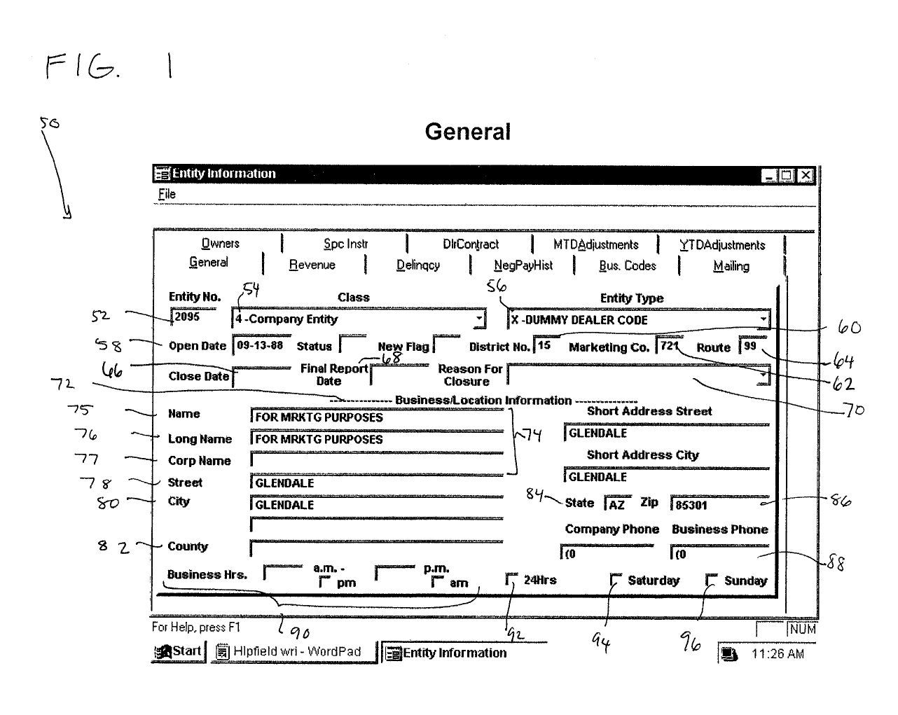

FIG. 1 depicts a preferred embodiment of the general information feature 50 of the present invention. The general information feature 50 provides basic information about the name, location, phone numbers, and primary business information about the entity. In a preferred embodiment of the invention, the general information feature 50 includes the entity number 52, the entity class 54, the entity type 56 and the open date 58 for the entity. The entity number 52 is a number that is assigned to each entity for identification purposes. The entity class 54 identifies the category to which the entity belongs for the purpose of determining commission rate earnings. The entity type 56 identifies the entity as a dealer, center, or other type of entity. The open date 58 indicate the date on which the entity was first opened for business.

To identify the supervisory organizational structure, the general information feature 50, preferably identifies the district number 60, the marketing number 62 and the route number 64 to which the entity belongs. If the entity has been closed, the general information feature 50 indicates the close date 66, the final report date 68, and the reason for closure 70.

The business/location information section 72 preferably includes the name of the business 74, the address 78, city 80, county 82, state 84, zip code 86 and telephone numbers 88. The business name 74 provided preferably includes the name used for marketing purposes 75, the long name 76 and the corporate name 77 of the entity. More preferably, the business/location information section 72 includes the business hours 90 of the entity, including an indicator of whether the entity is open 24 hours 92, Saturdays 94 and Sundays 96.

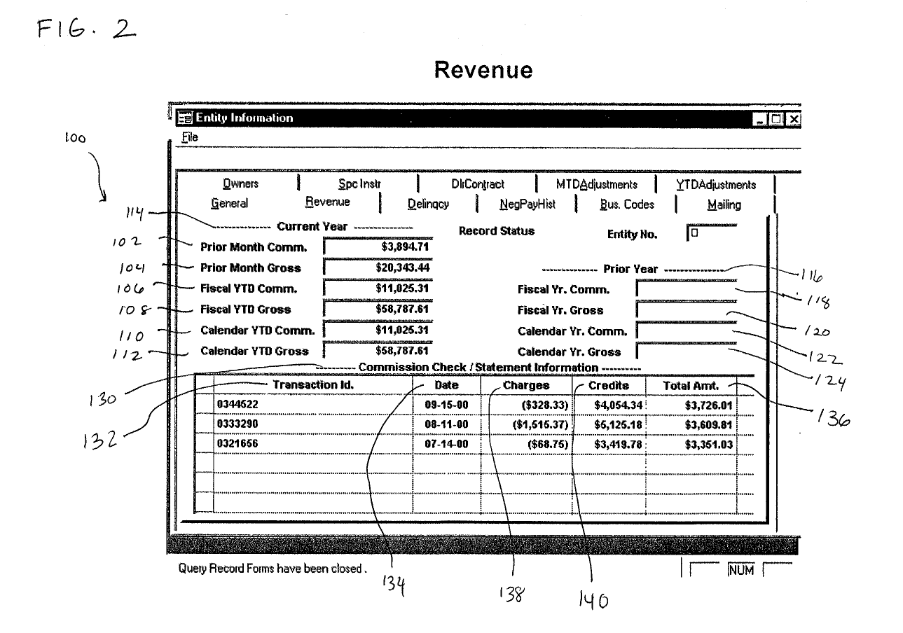

FIG. 2 depicts a preferred embodiment of the revenue tracking feature 100 of the present invention. The revenue tracking feature 100 displays the commission and gross revenue information for a specified entity. In a preferred embodiment of the invention, the revenue tracking feature 100 includes a prior month commission 102, the prior month gross revenues 104, the fiscal year to date commission 106, the fiscal year to date gross revenues 108, the calendar year to date commission 110, and the calendar year to date gross revenues 112. The revenue tracking feature 100 preferably provides the gross revenue and commission information with respect to the current year 114 and the previous year 116. The previous year 116 information preferably includes the fiscal year commission 118, fiscal year gross revenues 120, calendar year commission 122, and calendar year gross revenues 124.

In a more preferred embodiment, the revenue tracking feature 100 provides commission check information 130. The commission check information 130 preferably includes the check number or transaction identification 132, the date of the check or transaction 134, and the total amount of the check or transaction 136. The total amount 136 is calculated by subtracting the total charges 138 incurred by the entity from the entity's total credits 140.

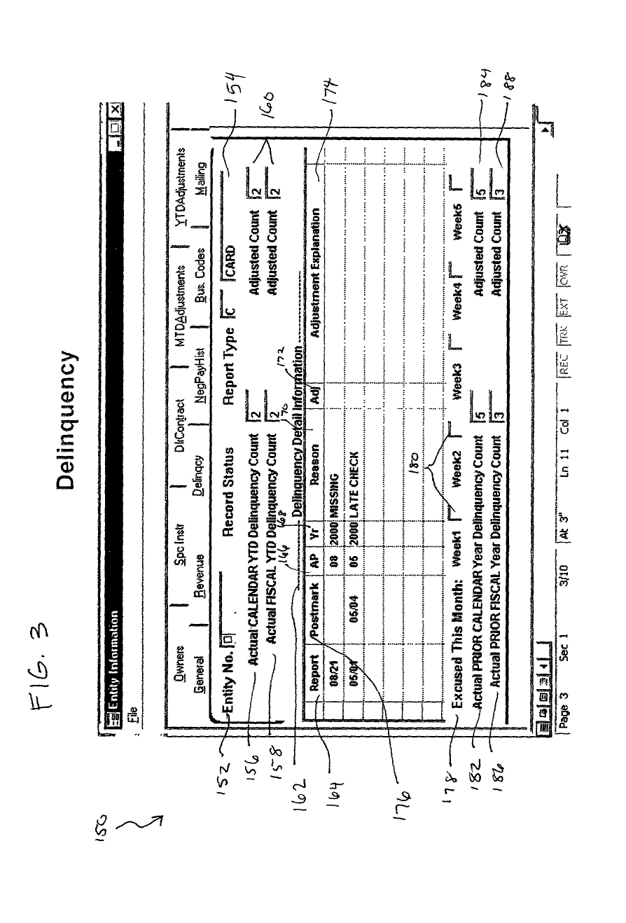

FIG. 3 depicts a preferred embodiment of the delinquency tracking feature 150 of the present invention. The delinquency tracking feature displays information pertaining to the delinquencies of a specified entity. In a preferred embodiment of the invention, the delinquency tracking feature 150 preferably includes the entity number 152, the type of reporting system 154 that is used by the entity in reporting gross revenues and commission, the actual calendar year to date delinquency count 156 and the actual fiscal year to date delinquency count 158. The actual delinquency count includes all delinquencies created at any time on the system mainframe.

Under some circumstances, it may be possible for an entity to obtain a delinquency override. For example, if a check that the entity provides to the central business concern is returned due to a bank error, the returned check will constitute a delinquency. However, because the returned check was due to a bank error and not due to any fault on the part of the entity, the central business concern may override the delinquency. In this situation, the actual delinquency count would reflect a delinquency for the returned check but the adjusted count 160 will not include a delinquency for the returned check. Similar overrides may be provided in situations wherein the entity was not at fault in causing the delinquency or special circumstances that warrant the pardon of the delinquency.

A delinquency detail information section 162 preferably provides specific information pertaining to each delinquency. In particular, the detail information section 162 provides the report date 164, accounting period 166 and year 168, the reason 170 for the delinquency, any adjustments 172 and an explanation 174 for the adjustment. If the reason for the delinquency is a late payment, the postmark date 176 of the payment is also provided.

If circumstances warrant, the entity may be excused from any delinquencies incurred during a specified period. The delinquency tracking feature 150 preferably identifies the period 178 for which the entity is excused from delinquencies. In the embodiment shown in FIG. 3, the delinquency tracking feature includes check boxes 180 for each week of the current month. By selecting a checkbox, the user identifies the week for which the entity is excused from any delinquencies.

For historical purposes, the delinquency tracking feature also includes an actual prior calendar year delinquency count 182 and its corresponding adjusted count 184, and the actual prior fiscal year delinquency count 186 and its adjusted count 188.

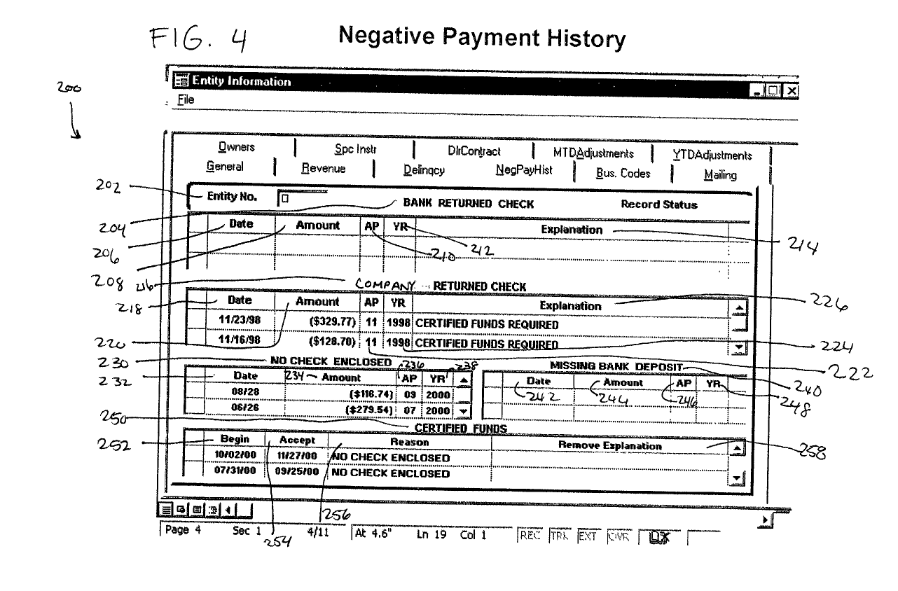

FIG. 4 depicts a preferred embodiment of the negative payment history feature 200 of the present invention. The negative payment history tracks the returned checks, missing deposits, missed payments and other negative payment history of a specified entity. In a preferred embodiment of the invention, the negative payment history feature 200 includes the entity number 202 and the bank returned checks 204. Each bank returned check 204 is preferably identified by the date 206 of the check, the amount 208, the accounting period 210 and year 212, and an explanation for the check's return 214 by the bank.

For some entities, the central business concern may have placed the entity on probation, accepting only certified checks from such entity. If the central business concern places a requirement of providing certified funds, the requirement is recorded in the certified funds section 250. The certified funds section 250 preferably identifies the date on which the requirement is instituted 252, the date that the requirement is lifted 254, the reason 256 that the requirement is imposed, and the explanation for removal of the requirement 258, when the requirement is removed.

If an entity on probation presents a non-certified check to the central business concern, the non-certified check is returned, and the transaction is recorded in the company returned check section 216. Each company returned check is preferably identified by the date 218, amount 220, accounting period 222 and year 224, and an explanation 226 stating the reason for returning the check.

If an entity mails a payment but the check is not enclosed, the transaction is recorded in the no check enclosed section 230. For such a transaction, the date 232, amount of the check 234, accounting period 236 and year 238 is recorded. Similarly, if an entity fails to make a required bank deposit, the failure to perform the transaction is recorded in the missing bank deposit section 240. The missing bank deposit section 240 preferably identifies the date 242, amount of the required deposit 244, accounting period 246 and year 248.

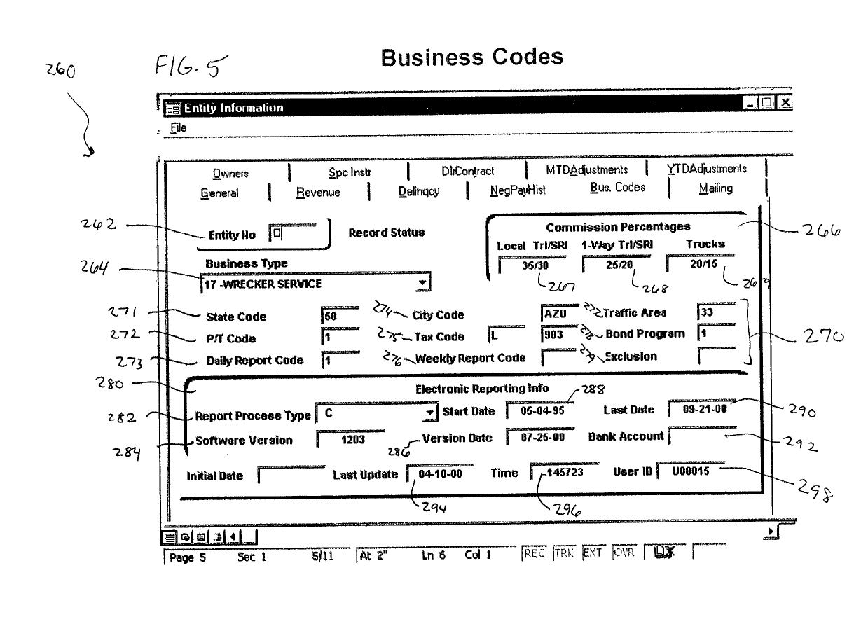

FIG. 5 depicts a preferred embodiment of the business codes feature 260 of the present invention. The business codes feature stores and displays various business codes for each entity. In a preferred embodiment of the invention, the business codes feature 260 preferably identifies the entity number 262, the business type 264, and the commission schedule 266. The commission schedule preferably specifies the commission rate to which the entity is entitled for renting various types of equipment. For example, in the embodiment shown in FIG. 5, the specified entity earns a commission rate of 30-35% for rental of local trailers 267, 20-25% for the rental of one-way trailers 268, and 15-20% for the rental of trucks 269.

The codes section 270 preferably provides detailed information pertaining to the entity by using preselected codes to identify the categories in which the entity belongs. In the embodiment shown in FIG. 5, the codes section 270 includes a state code 271, a p/t code 272¹, a daily report code 273, a city code 274, a tax code 275, a weekly report code 276, the traffic area 277, bond program code 278,² and exclusion code 279.³ The state code 271 identifies the state in which the entity is located. The daily report code 273 identifies the manner in which the entity provides the central business concern with its daily report. The city code 274 identifies the city in which the entity is located. The tax code 275 identifies the tax treatment for the entity.⁴ The weekly report code 276 identifies the manner in which the entity generates its weekly report. The traffic area 277 identifies the marketing company which oversees the entity. 1/ What is a p/t code? 2/ What is the bond program code? 3/ What is the exclusion code? 4/ Is this correct?

If the entity reports its revenues electronically, the business codes feature 260 preferably includes electronic reporting information 280. The electronic reporting information 280 identifies the report process type 282, which specifies the software that is used in the reporting process. If no software is used, the report process type 282 indicates that the reporting is done manually. However, if the entity utilizes reporting software, the software version 284 and the version date 286 are provided. The electronic reporting information preferably includes the start date 288 and last date 290 of the electronic reporting. If the electronic reporting is linked to a bank account, the bank account number 292 is also provided.

The system preferably tracks any changes to the electronic reporting information and identifies the last update 294, time of last update 296 and the identification of the user 298 who performed the update.

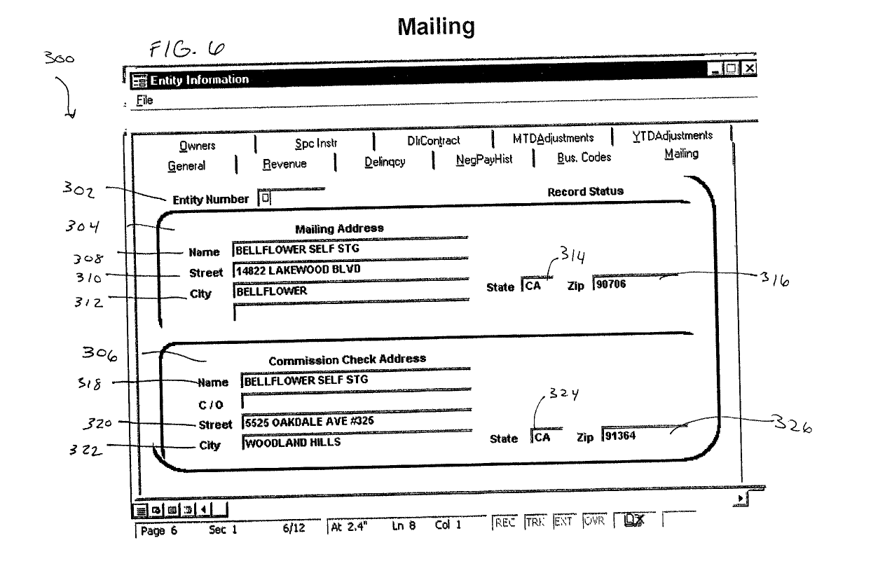

FIG. 6 depicts a preferred embodiment of the mailing information feature 300 of the present invention. The mailing information features displays the address information for a specified entity. In a preferred embodiment of the invention, the mailing information feature 300 includes the entity number 302, the mailing address 304 and the commission check address 306. The mailing address is the location to which all business related mail will be directed except for the entity's commission check. The mailing address 304 preferably includes the entity name 308, address 310, city 312, state 314, and zip code 316.

The commission check address 306 is the address to which the entity's commission check will be mailed. If a person is the owner of several different entities, the owner may wish to receive its business mail at each individual entity, but receive its commission for all of its entities at one location. This feature of the invention provides the owner with this option. The commission check address 306 preferably includes the entity name 318, address 320, city 322, state 324, and zip code 326.

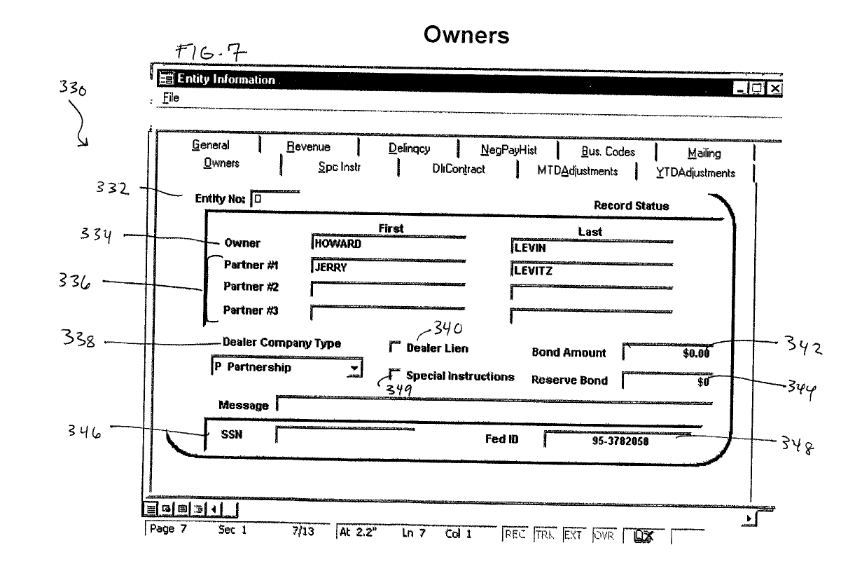

FIG. 7 depicts a preferred embodiment of the owner identification feature 330 of the present invention. The owner identification feature provides information pertaining to the ownership of the entity. In a preferred embodiment of the invention, the owner identification feature 330 includes the entity number 332, the identity of the owner 334 and the identity of any partners 336. The business type field 338 indicates whether the entity is a sole proprietorship, partnership, corporation or other type of legal entity. A lien indicator 340 is provided to signals the existence of a lien on the entity. If a bond is posted, the bond amount 342 and the reserve bond amount 344 are provided.

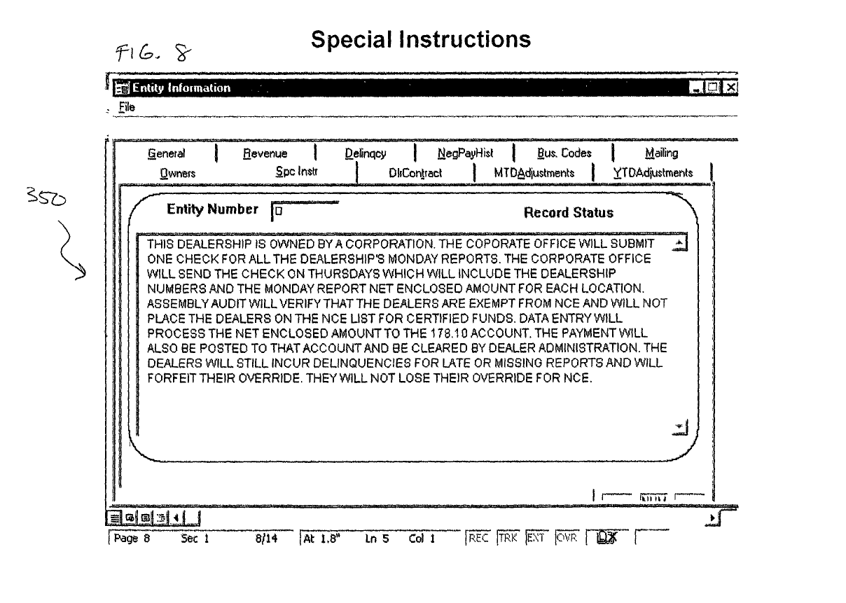

For sole proprietorships, the social security number 346 of the owner is provided. For other types of business, the federal tax identification number 348 is provided. A special instructions indicator 349 signals the existence of special instructions for treatment of the specified entity. To determine the exact nature of the special instructions, the system preferably includes a special instructions display 350, as shown in FIG. 8, that dictates the specific instruction that are to be followed in handling the specified entity. The special instruction may relate to reporting or commission payment instructions or any other type of information that is useful in conducting business with the particular entity. In a preferred embodiment of the invention, the special instructions identify the provisions of the standard dealer contract that the entity and the central business concern have agreed to alter.

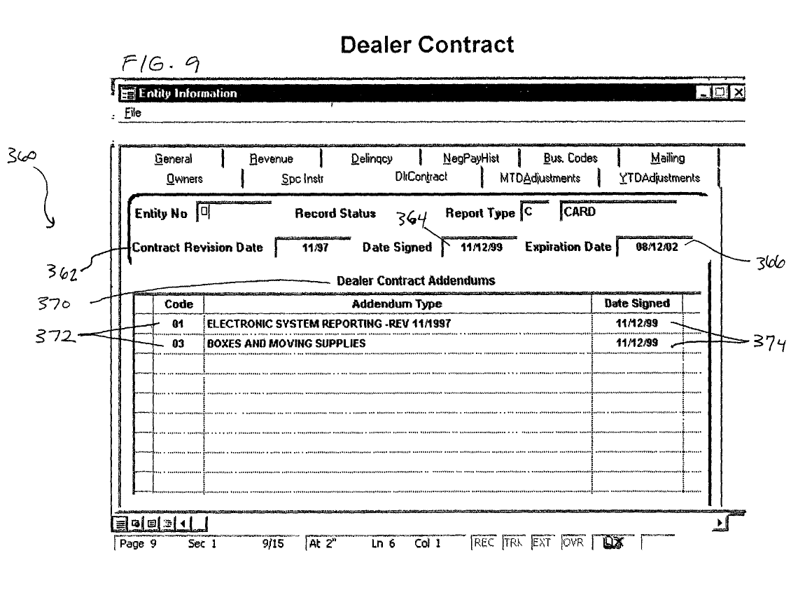

FIG. 9 depicts a preferred embodiment of the contract information feature 360 of the present invention. The contract information feature identifies any contracts and addendums into which the entity has entered with the central business concern. In a preferred embodiment of the invention, the contract information feature 360 includes the contract revision date 362, the execution date 364 of the agreement and the expiration date 366 of the agreement. The contract revision date 362 enables the user to identify the version of the contract that the entity has signed. The contract information feature 360 preferably includes an addendum section 370 that identifies any addendum to the contract 372, and the execution date 374 of the addendum. For example, in the embodiment shown in FIG. 9, the specified entity has entered into an electronic system reporting addendum and a boxes and moving supplies addendum. In a preferred embodiment, the entity will sign an addendum for each program in which the entity is participating in, e.g., electronic reporting, moving supplies sales, and carpet cleaning supplies rentals.

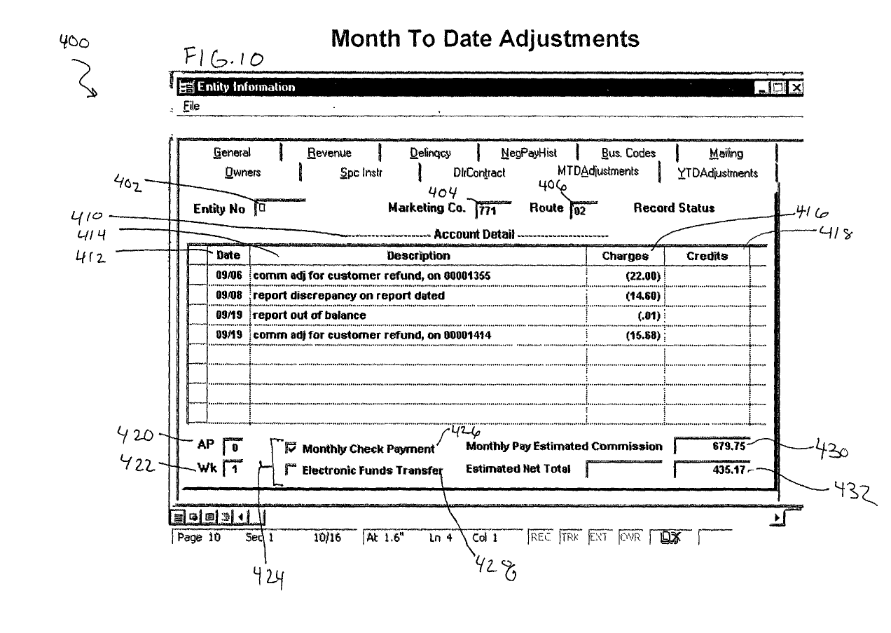

FIG. 10 depicts a preferred embodiment of the month to date adjustment report 400 of the present invention. The month to date adjustment report displays accumulated account detail information for the current month, which includes all debit and credit transactions applied against the entity's commission payment. In a preferred embodiment of the invention, the month to date adjustment report 400 identifies the entity by the entity number 402, marketing company number 404 and route number 406. An account detail section 410 is provided which lists the date 412 of each transaction and a description 414 of the transaction. For each entry, a charge amount 416 or credit amount 418 is provided.

The month to date adjustment report 400 preferably identifies the accounting period 420 and the week number 422. The payment type 424 is provided to inform the user of the method of payment of the commission to the entity. In a preferred embodiment of the invention, the payment type 424 is selected from one of the following options: a monthly check payment 426 or an electronic funds transfer 428.

The month to date adjustment report 400 provides a monthly pay estimated commission 430 which is based on the average commission payment that is made to the entity. Based on the transactions recorded in the account detail 410, the system calculates the estimated net total 432 of the commission check for the current month. The estimated net total 432 is updated upon entry of a new charge or credit transaction.

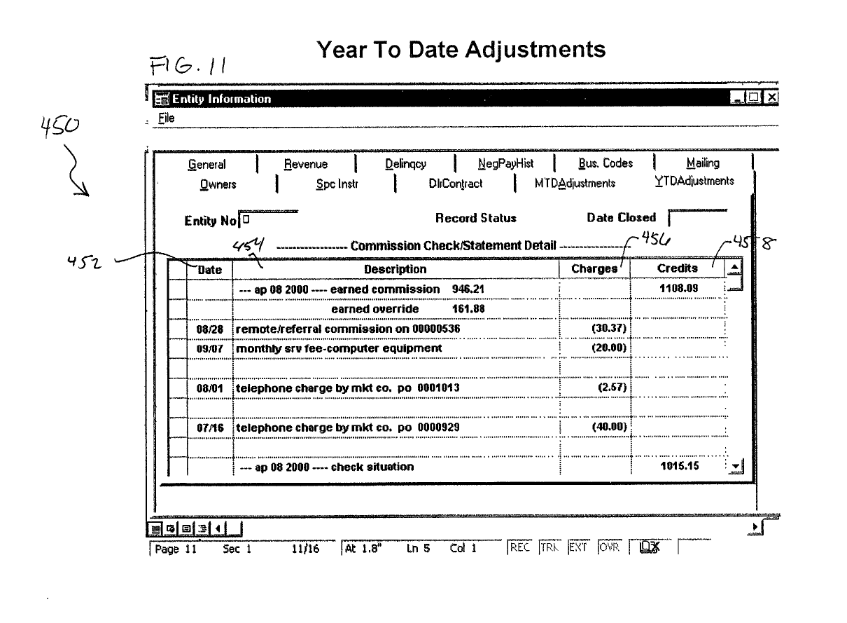

FIG. 11 depicts a preferred embodiment of the year to date adjustment report 450 of the present invention. The year to date adjustment report displays the debit and credit transactions that have been applied against an entity's commission payment from the beginning of the year to the present. In a preferred embodiment of the invention, the year to date adjustment report 450 includes the date 452 of each transaction and a detailed description 454 of the transaction. For each entry, a charge amount 456 or a credit amount 458 is identified. The report preferably indicates the amount and date of each commission check paid, and maintains a running balance of the commission check due for the current month.

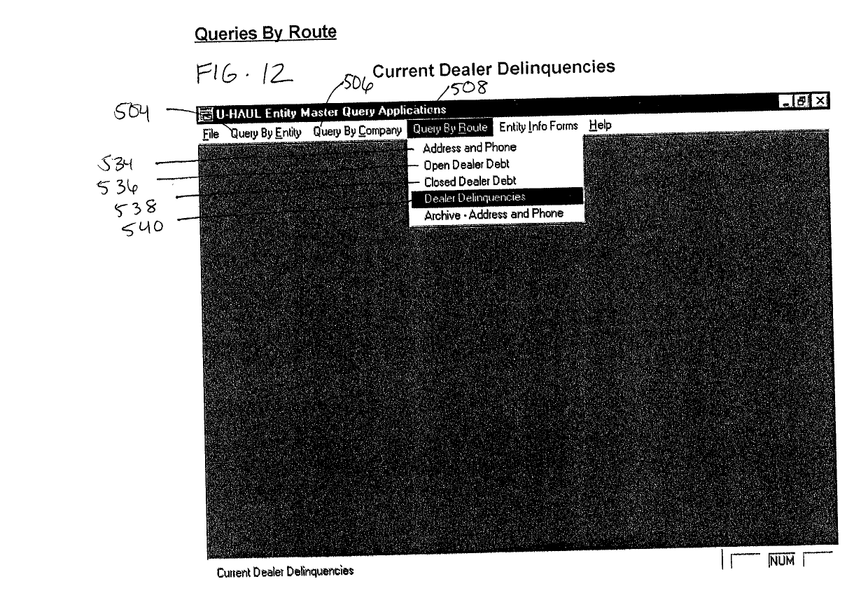

The electronic entity records system is preferably searchable by any field. In a preferred embodiment of the invention, for the user's convenience, the system includes pre-formed queries 500, as shown in FIG. 12, that can be selected from drop down menus 502. The pre-formed queries 500 are categorized by queries by entity 504, queries by company 506, and queries by route 508. The queries by entity 504 includes the following query options: business name 510, city/state 512, entity by state 514, entity by county 516, entity by district 518, owner name 520, tax identification 522 and archived 524. The business name query 510 enables the user to input a business name, in response to which the system outputs the entity number, status, marketing company, route, and location of the entity. The city/state query 512 enables the user to enter a city and a state abbreviation, in response to which the system outputs the entity number, status, business name and location of every entity in the specified city and state. Similarly, the entity by state 514 and entity by county 516 queries provide entity information for the specified state and county, respectively.

The entity by district query 518 enables the user to input the district number, in response to which the system provides the entity number, status, marketing company number, route number and location of every entity in the specified district. The owner name query 520 enables a user to input an owner's name, in response to which the system outputs the entity number, status, and business name of the entity owned by the owner specified. The tax identification query 522 enables the user to input a social security number or federal tax identification number, in response to which the system outputs the entity number, status, business code and the owner's name. The archived query 524 enables the user to search information pertaining to entities that are no longer valid entities.

The queries by company feature 506 includes the following query options: address and phone 526, current open dealer debt 528, current closed dealer debt 530 and current dealer delinquencies 532. The address and phone query 526 enables the user to enter a marketing company number, in response to which the system identifies every entity in the marketing company by entity number, status, route, entity name, location and phone number. The current open dealer debt query 528 enables the user to input a marketing company number, in response to which the system identifies all entities that currently have charges exceeding credits that still have open accounts. The entities are preferably identified by entity number, status, route, and outstanding debt amount. The current closed dealer debt query 530 enables the user to enter a marketing company number, in response to which the system identifies the entities that have charges exceeding credits, and wherein the account has been closed but not yet sent to collections. The entities are preferably identified by entity number, status, route and the outstanding debt amount. The current dealer delinquencies query 532 enables the user to enter a marketing number, in response to which the system identifies the entities within the marketing company that currently have delinquencies. The entities are preferably identified by entity number, status, route, report date for the current accounting period, the reason for the delinquency, the accounting period, and the year to date fiscal adjusted delinquency count.

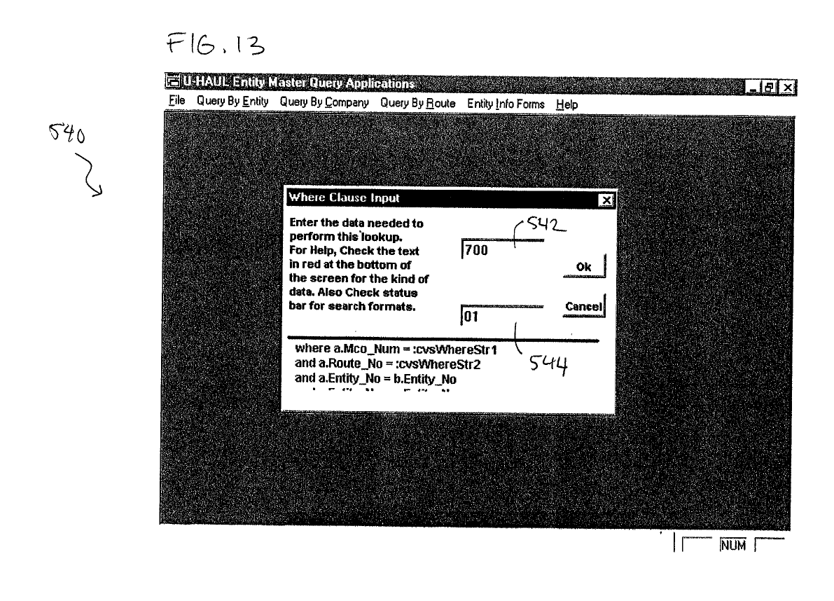

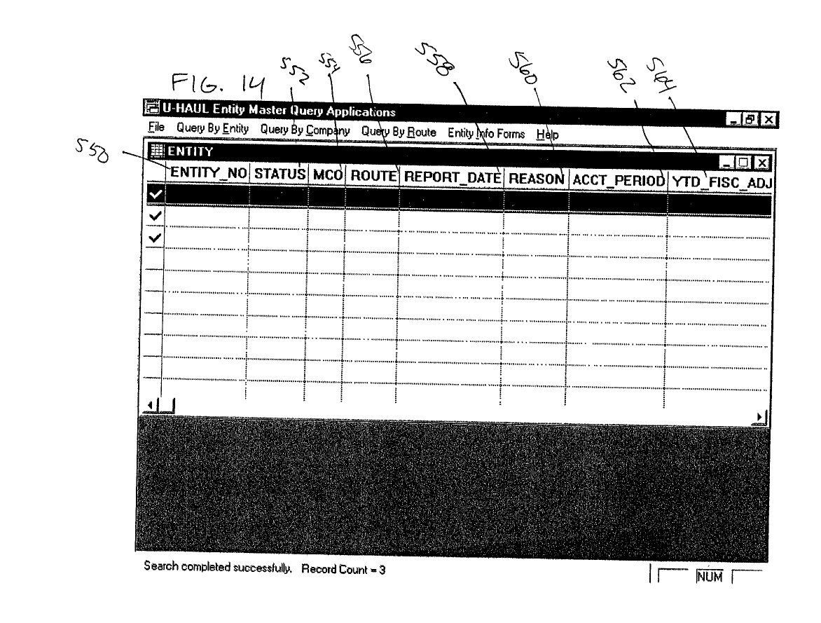

The queries by route 508, as shown in FIG. 12, preferably includes the following query options: address and phone 534, current open dealer debt 536, current closed dealer debt 538 and current dealer delinquencies 540. The address and phone query 534 enables the user to enter a marketing company number and a route number, in response to which the system identifies every entity in the specified marketing company and route by entity number, status, route, entity name, location and phone number. The current open dealer debt query 536 enables the user to input a marketing company number and a route number, in response to which the system identifies all entities in the specified marketing company and route that currently have charges exceeding credits and that still have open accounts. The entities are preferably identified by entity number, status, route, and outstanding debt amount. The current closed dealer debt query 538 enables the user to enter a marketing company number and a route number, in response to which the system identifies the entities in the specified marketing company and route that have charges exceeding credits, and wherein the account has been closed but not yet sent to collections. The entities are preferably identified by entity number, status, route and the outstanding debt amount. The current dealer delinquencies query 540, as shown in FIG. 13, enables the user to enter a marketing number 542 and route number 544, in response to which the system identifies the entities within the specified marketing company and route that currently have delinquencies. As shown in FIG. 14, the entities are preferably identified by entity number 550, status 552, marketing company 554, route 556, report date 558 for the current accounting period, the reason for the delinquency 560, the accounting period 562, and the year to date fiscal adjusted delinquency count 564.

The electronic entity records system of the present invention is a useful tool for a central business concern and its various marketing companies, route managers and entities that enables the user to verify dealer addresses (both mailing and location), verify telephone numbers, locate entities by city or state, locate entities by business name or owner name. For supervisors, the records system can be used to obtain a detailed commission statement for each entity, maintain information pertaining to signed contracts and addendum for each entity, receive detailed information regarding certified funds and negative payment history, track an entity's delinquency history and maintain a record of revenues generated by each entity.

The embodiments described above are exemplary embodiments of an electronic entity records system. Those skilled in the art may now make numerous uses of, and departures from, the above-described embodiments without departing from the inventive concepts disclosed herein. Accordingly, the present invention is to be defined solely by the scope of the following claims.

What is claimed is:

1. An entity records system for tracking information pertaining to a plurality of entities, the system comprising:
an entity identification capture to record identification information for each entity;
a revenue capture in data communication with the entity identification capture to record revenue information for the entity;
a delinquency data capture in data communication with the entity identification capture to record account delinquency information for each entity; and
a negative payment history capture in data communication with the entity identification capture to track the negative payment history for each entity.

2. The entity records system of claim 1 wherein the entity identification capture comprises a business name, an address, and a business telephone number.

3. The entity records system of claim 1 wherein the entity identification capture identifies a district number, a marketing number and a route number for a specified entity.

4. The entity records system of claim 1 wherein the entity identification capture identifies the business hours for a specified entity.

5. The entity records system of claim 1 wherein the revenue capture comprises a prior month commission total.

6. The entity records system of claim 1 wherein the revenue capture comprises a prior month gross revenue total.

7. The entity records system of claim 1 wherein the revenue capture comprises a year to date commission total.

8. The entity records system of claim 1 wherein the revenue capture comprises a year to date revenue total.

9. The entity records system of claim 1 wherein the revenue capture identifies a commission payment by displaying a check number, a check date and a check amount corresponding to the commission payment.

10. The entity records system of claim 1 wherein the delinquency data capture comprises a delinquency count.

11. The entity records system of claim 1 wherein the delinquency data capture identifies an account delinquency by providing a delinquency date and a reason for the delinquency.

12. The entity records system of claim 10 wherein the delinquency data capture identifies an adjustment in the delinquency count.

13. The entity records system of claim 1 wherein the negative payment history capture comprises a bank returned check capture.

14. The entity records system of claim 1 wherein the negative payment history capture comprises a company returned check capture.

15. The entity records system of claim 1 wherein the negative payment history capture comprises a missing check capture.

16. The entity records system of claim 1 wherein the negative payment history capture comprises a missing bank deposit capture.

17. The entity records system of claim 1 wherein the negative payment history capture comprises a certified funds requirement indicator.

18. The entity records system of claim 1 further comprising a commission schedule for a specified entity.

19. The entity records system of claim 1 further comprising a commission check mailing address.

20. The entity records system of claim 1 further comprising an owner identification feature.

21. The entity records system of claim 1 further comprising a contract information capture.

22. The entity records system of claim 21 wherein the contract information capture includes an addendum information capture.

23. The entity records system of claim 1 further comprising a month to date adjustments capture.

24. The entity records system of claim 1 further comprising a year to date adjustments capture.

25. An entity records system for tracking information pertaining to a plurality of entities, the system comprising:
an entity identification capture to record identification information for each entity; and
a revenue capture in data communication with the entity identification capture to record revenue information for the entity.

26. The entity records system of claim 25 wherein the entity identification capture comprises a business name, an address, and a business telephone number.

27. The entity records system of claim 25 wherein the entity identification capture identifies a district number, a marketing number and a route number for a specified entity.

28. The entity records system of claim 25 wherein the entity identification capture identifies the business hours for a specified entity.

29. The entity records system of claim 25 wherein the revenue capture comprises a prior month commission total.

30. The entity records system of claim 25 wherein the revenue capture comprises a prior month gross revenue total.

31. The entity records system of claim 25 wherein the revenue capture comprises a year to date commission total.

32. The entity records system of claim 25 wherein the revenue capture comprises a year to date revenue total.

33. The entity records system of claim 25 wherein the revenue capture identifies a commission payment by displaying a check number, a check date and a check amount corresponding to the commission payment.

34. An entity records system for tracking information pertaining to a plurality of entities, the system comprising:
an entity identification capture to record identification information for each entity; and
a delinquency data capture in data communication with the entity identification capture to record account delinquency information for each entity.

35. The entity records system of claim 34 wherein the delinquency data capture comprises a delinquency count.

36. The entity records system of claim 34 wherein the delinquency data capture identifies an account delinquency by providing a delinquency date and a reason for the delinquency.

37. The entity records system of claim 35 wherein the delinquency data capture identifies an adjustment in the delinquency count.

38. An entity records system for tracking information pertaining to a plurality of entities, the system comprising:
an entity identification capture to record identification information for each entity; and
a negative payment history capture in data communication with the entity identification capture to track the negative payment history for each entity.

39. The entity records system of claim 38 wherein the negative payment history capture comprises a bank returned check capture.

40. The entity records system of claim 38 wherein the negative payment history capture comprises a company returned check capture.

41. The entity records system of claim 38 wherein the negative payment history capture comprises a missing check capture.

42. The entity records system of claim 38 wherein the negative payment history capture comprises a missing bank deposit capture.

43. The entity records system of claim 38 wherein the negative payment history capture comprises a certified funds requirement indicator.

44. A method of tracking information pertaining to a plurality of entities, the method comprising the steps of:
storing and retrieving entity identification data;
storing and retrieving revenue information pertaining to the entities;
storing and retrieving delinquency data pertaining to the entities; and
storing and retrieving negative payment history pertaining to the entities.

45. The method of claim 44, further comprising the steps of:
providing a searchable database having a query field;
wherein in response to the input of an entity identifier, at least one of the entity identification data, revenue information, delinquency data or negative payment history is displayed.
